(19) United States
(12) Patent Application Publication
(10) Pub. No.: US 2008/0165649 A1
(43) Pub. Date: Jul. 10, 2008

(54) Tangential Disc Tilt Measurement and Corrective Action

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,089

(22) PCT Filed: Jul. 27, 2006
(86) PCT No.: PCT/IB2006/052132

§ 371 Date: Dec. 27, 2007

Related U.S. Application Data
(60) Provisional application No. 60/695,067, filed on Jun. 29, 2005.

(30) Foreign Application Priority Data
Jun. 27, 2006 (IB) PCT/IB2006/052132

(51) Int. Cl. G11B 7/00; G11B 11/00

(52) U.S. Cl. 369/53.19

(57) ABSTRACT

A method and system within optical disc player/recorders that measures tangential disc tilt and provides for responsive action. Optical discs inevitably show some degree of warping. By determining the tangential tilt angles over the disc and comparing these tilt angles with a prescribed maximum allowed tilt angle, responsive actions are taken if the maximum tilt angle is exceeded to stop operation or adjust the tangential lens tilt to compensate for the tangential disc tilt usig with a bandwidth suitable for high rotational speeds.

The present invention pertains to optical disc player recorders and, more particularly to corrective actions taken for warping that occurs within an optical media that is used within the player/recorder.

Optical disc technology continues to increase the density for data that can be recorded on an optical disc. The maximum data density that can be recorded on an optical disc varies inversely with the size of the laser spot that is focused on the disc. The spot size is determined by the ratio of two optical parameters: the wavelength λ of the laser and the numerical aperture (NA) of the objective lens. Therefore, recent standards have provided light beam sources, such as laser diodes, that have short wavelengths. Among these standards are Blu-ray Disc (BD) that employ wavelengths of about 405 nm and HTDVD. In order to decrease the spot size, optical configurations have been introduced that increase the NA. Among these optical configurations are near field configurations that have a very short distance between the record carrier being focused upon and the final optical lens within the optical path before the record carrier.

A problem that exists within the prior art is that most storage media inevitably show some degree of warping. This warping results in tilt once the warped disc is used within an optical disc system. This is especially true of inexpensive discs, such as injection molded polycarbonate discs having a thickness of around 1.2 mm; which thickness is typically limited by material cost as well as cartridge and drive height. If an injection molded polycarbonate disc is used within an optical system employing a typical near field lens set-up having a solid immersion lens (SIL) exit surface diameter of 40 μm and an air gap of 25 nm between the SIL exit surface and the disc, the maximum allowed mechanical tilt tolerance is about ±1.25 mrad or ±0.07°. This small tolerance requires accurate alignment, but even then this tolerance is ‘dangerously’ close to the tangential tilt angles that can occur in practical record carriers, especially in lower-quality discs.

Therefore, in order to address the above discussed shortcomings within the prior art, it is proposed herein that tangential tilt angles be determined over the disc in a fast and inexpensive manner. These tilt angles are then checked to insure that they are smaller than a prescribed maximum that is allowed for tilt angles. Embodiments are discussed wherein operation is stopped or the disc is entirely refused by the play/recorder. Further embodiments dynamically adjust the tangential lens tilt to compensate for the tangential disc tilt, with a bandwidth suitable for high rotation speeds and thus data rates. Such an active tilt control can improve the media manufacturing tolerances, and/or the drive performance and reliability for a given media quality.

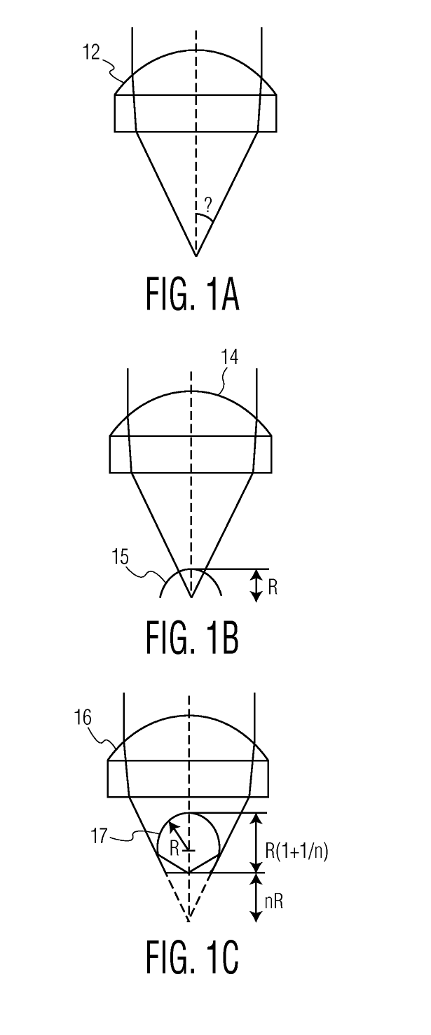

FIG. 1 is a diagram illustrating a lens focusing in air;

FIG. 1 b is a diagram illustrating a lens focusing in hemispherical SIL;

FIG. 1 c is a diagram illustrating a lens focusing in a planatic super-hemispherical SIL

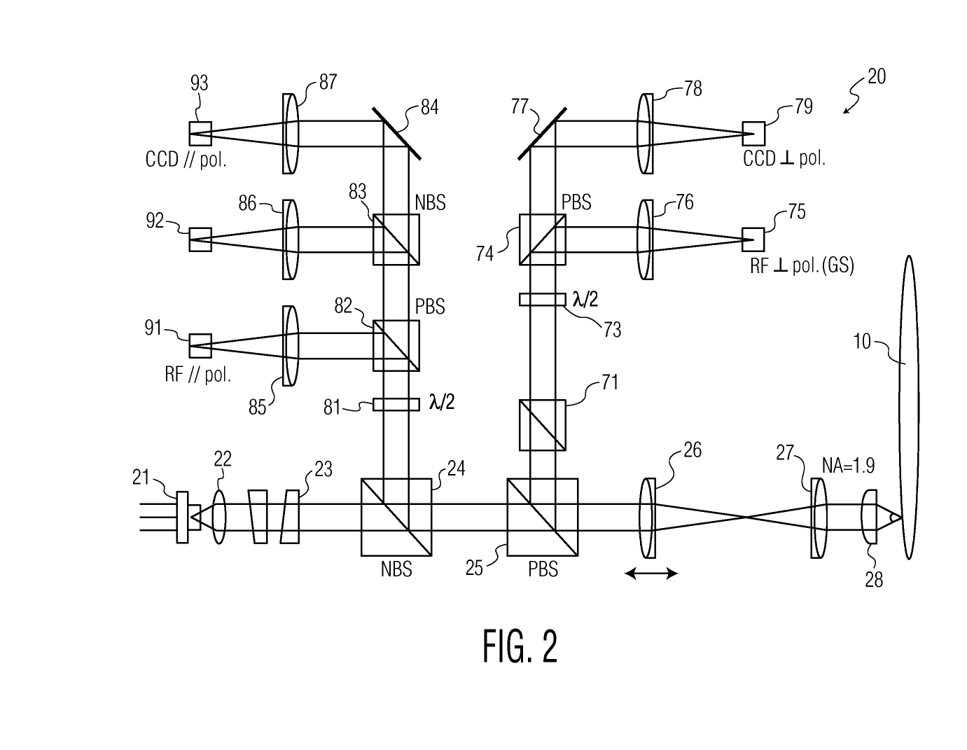

FIG. 2 is a schematic diagram for optics that can be used with of a near field player;

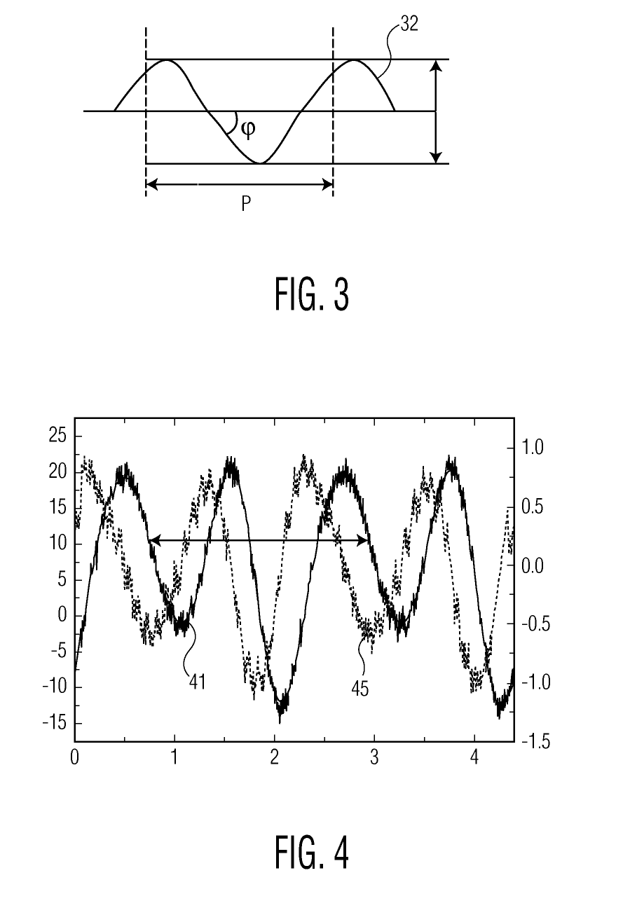

FIG. 3 is an illustration for an example of axial runout during a disc rotation having a period P indicating the local tangential tilt angle φ;

FIG. 4 is an illustration of axial runout and corresponding tangential tilt over almost two rotations on a polycarbonate disc having a 1.2 mm thickness and a of about 35 mm; and

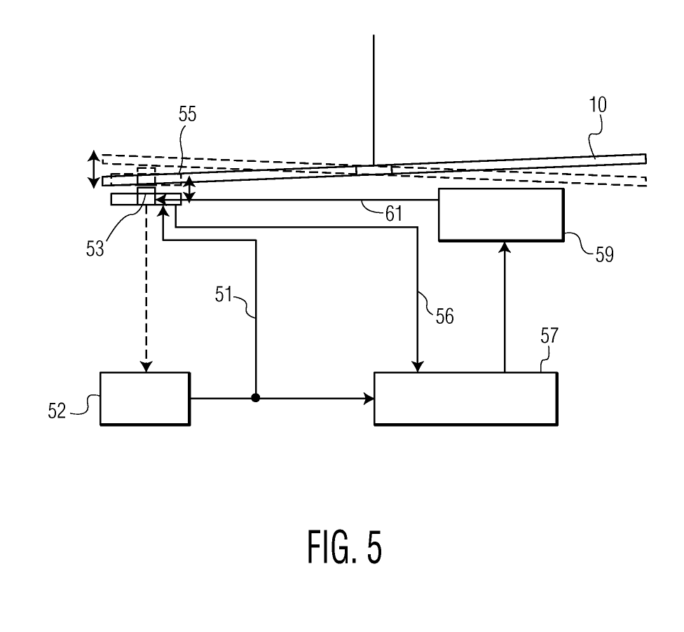

FIG. 5 is a diagram showing signals and circuits used for tilt angle control.

FIG. 1a illustrates an objective lens 12 focusing at a point through an air medium. The numerical aperture (NA) of the objective lens 12 is defined as NA=n sin(θ), where n is the refractive index of the medium in which the light is focused, and θ is the half angle of the focused cone of light in that medium. It will be readily understood by those skilled in the art, that the upper limit for the NA of the objective lens 12 focusing in air or through a parallel plane (such as a flat disc) is unity.

FIG. 1b illustrates an objective lens 14 focusing in the centre of a hemispherical solid immersion lens (SIL) 15. The NA of a lens can exceed unity if the light is focused in a high index medium without refraction at the air-medium interface, for example by focusing in the centre of a hemispherical SIL 15 as shown in FIG. 1b. The hemispherical SIL shown FIG. 1b, has an effective NA is Na_{eff}=nₗₑₙₛNA₀ with nₗₑₙₛ being the refractive index of the hemispherical SIL 15 and NA₀ being the NA in air of the focusing objective lens 14.

FIG. 1c illustrates that a further increase in the NA can be achieved by objective lens 16 focusing in a super-hemispherical SIL 17 to refract the beam towards the optical axis. The super-hemispherical SIL 17 shown in FIG. 1c has an effective NA of Na_{eff}=n² NA₀. It should be noted that the effective NA_{eff} will be larger than unity only within an extremely short distance, this short distance is referred to as the near-field. The near field is the very short distance from the exit surface of the super-hemispherical SIL 17, typically smaller than 1/10^{th} of the wavelength of the light. Thus, during writing or read-out of an optical disc, the distance between super-hemispherical SIL 17 and disc is smaller than of few tens of nanometers.

If an entrance face of an optical record carrier is arranged within this short distance (near-field), radiation is transmitted from the super-hemispherical SIL 17 to the record carrier by evanescent coupling. This means that during writing or read-out of an optical disc, the distance between the super-hemispherical SIL 17 and disc, or the gap width, should be smaller than a few tens of nanometers, for example, about 25 nm for a system using a blue laser as radiation source and an NA of the objective system of 1.9. In what is generally referred to within the art as an air-incident optical record carrier, one side of the information layer is in contact with a substrate and the other side is exposed to the environment. The entrance face of such a record carrier is the interface between the information layer and the environment. Alternatively, the information layer can be protected from the environment by a thin transparent layer on the outer surface of the entrance face of the record carrier; in which case the super-hemispherical SIL 17 must correct for the thickness of the transparent layer.

In order to control of the width of the air gap at such small distances, a mechanical actuator controlled by a servo system is employed. A suitable control signal is required as an input for the servo system that controls the width of the air gap. As taught by T. Ishimoto et al. in the paper Optical Memory published in: Tech Dig. Optical Data Storage, in 2001 in Santa Fe., a suitable gap signal can be obtained from the reflected light with a polarization state perpendicular to that of the forward radiation beam that is focused on the record carrier. A significant fraction of the light becomes elliptically polarized after reflection at the SIL-air-record carrier interfaces: this effect creates the well-known Maltese cross when the reflected light is observed through crossed polarizers. Integrating all the light of this Maltese cross using polarizing optics and a radiation detector, which can be a single photodetector, generates the gap signal. The value of gap signal is zero for zero gap width and increases with increasing gap width and levels of at a maximum value when the gap width is approximately a tenth of the wavelength. The desired gap width corresponds to a certain value of the gap signal, the set-point. The gap signal and a fixed voltage equal to the set-point are input in a subtractor, which forms a gap error signal at its output. The gap error signal is used to control the gap servo system.

FIG. 2 is a schematic of a near field set-up, generally referred to as 20. The near field set-up 20 is a scanning device capable of forming a gap control signal. Laser 21 produces a beam of light for use with the near field set-up 20. The wavelength of the light that is used for a near field set-up 20 is a short wavelength. For example, the near field set-up 20 illustrated in FIG. 2 employs a laser 21 with a 405 nm wavelength as typically used within Blu-ray disc (BD) types of optical media. However, it will be readily apparent to those skilled within the art that various wavelengths can be used in other near field set-ups. Collimating lens 22 receives the beam of light from laser 21 and forms a collimated beam of light which is shaped by beam shaper 23. Non-polarizing beam splitter (NBS) 24 transmits a portion of the light beam from beam shaper 23 towards polarizing beam splitter (PBS) 25. PBS 25 in turn transmits a portion of the light beam towards focus optics 26. Focus optics 26 has an adjustment mechanism that provides for adjustment of the focal length of the beam of light that will become incident upon optical media 10. Between focus optics 26 and optical media 10, are lens 27 and SIL 28 which create the near field in a manner as previously described. As shown in FIG. 2, a NA of 1.9 is created by the near field set-up by lens 27 and SIL 28. Those skilled within the art will readily understand the example shown in FIG. 2 is only a single embodiment and that various lens configurations can be used in place of lens 27 and SIL 28 and that different numerical apertures other then NA-1.9 can be created. Light reflected by optical media 10 will return through the near field to SIL 28 and through lens 27 and a portion will be reflected by PBS 25 to polarizer 71. A phase offset of 180° is created in the light from polarizer 71 by half wave plate (λ/2) 73. The phase offset light beam from half wave plate 73 is partially reflected by PBS 74 through lens 76 to be detected by detector 25. PBS 74 passes the remainder of the light from half wave plate 73 onto mirror 77 which reflects that light through lens 78 onto detector 79.

Still referring to FIG. 2, light reflected by the optical media 10 that is not reflected by PBS 25 to polarizer 71 is transmitted to NBS 24 which reflects a portion of that light through half wave plate (λ/2) 81 that offsets the light by 180°. From have wave plate 81, a portion of the light is reflected by PBS 82 through lens 85 onto detector 91. Light not reflected by PBS 82 is passed through to NBS 83 that will reflect a portion of that light through lens 86 onto detector 92 and pass the remaining portion to mirror 84 that reflects that portion through lens 87 onto detector 93.

The near field set-up 20 employs two RF signal detectors. The first RF detector is detector 91, indicated by “RF//pol.”, is used for detection of light that is polarized parallel to the forward radiation beam focused on the optical media 10 and contains the information read from the information layer. The second RF detector is detector 75, indicated by “RF⊥pol.”, detects light that is polarized perpendicular to direction of polarization of the forward radiation beam that is focused on the optical media 10. The gap signal (GS) is derived from the low-frequency part (e.g. DC to 30 kHz) of the light that is polarized perpendicular to direction of polarization of the forward radiation beam that is focused on the optical media 10 (the “RF⊥pol.” signal).

As previously discussed, storage media, and especially inexpensive media, such as injection molded polycarbonate discs inevitably show some degree of warping. Changes in temperature and/or humidity also affect the shape of these media. Typical maximum tangential tilt angles for well-controlled, conventional disc technology are in the order of 0.03°=0.5 mrad, but larger angles often occur for lower quality discs. The tilt in the radial direction is typically larger, but also varies much more slowly, and can thus be measured and compensated for all ranges of radial positions by adjusting the angle of the disc with respect to the optical axis or vice versa by tilting of the entire Optical Pick-up Unit (OPU). The same method can be used to measure and compensate the average or ‘DC’ tangential tilt (due to misalignment of the disc). The remaining tangential tilt will ideally only contain contributions from the shape of the disc.

For a typical near field lens with a SIL exit surface diameter of 40 μm and an air gap of 25 nm, the maximum allowed mechanical tilt tolerance is ±1.25 mrad or ±0.07°. This small tolerance requires accurate alignment, but even then this tolerance is ‘dangerously’ close to the tangential tilt angles that can occur in practical record carriers, especially in lower-quality discs (see e.g. FIG. 3). Quasi-static methods have been proposed do not provide a practical solution, as this would require extremely low disc rotation velocities and therefore very low data rates.

Therefore, an embodiment proposes determining the tangential tilt angles over the disc, in a fast and inexpensive manner, checking these tilt angles to insure that they are smaller than a prescribed maximum allowed tilt angle and otherwise stop operation and refuse the disc, or finally dynamically adjust the tangential lens tilt to compensate for the tangential disc tilt, with a bandwidth suitable for high rotation speeds and thus data rates. Such an active tilt control can improve the media manufacturing tolerances, and/or the drive performance and reliability for a given media quality.

FIG. 3 is an example of axial runout 32, generally referred to as “r”, that can occur during a disc rotation period, indicated by arrow P. FIG. 3 indicates the local tangential tilt angle φ that occurs as a result of the axial runout of the disc. This axial runout results in the local tangential tilt angle φ.

FIG. 5 is a diagram showing signals and circuits that are used for controlling the tilt angle. The local tangential tilt angle φ is measured by the gap signal, generated as previously describe or using other methods, goes to the gap servo 52. The gap servo 52 generates a gap control/runout signal 51 which is input to the lens tilt actuator 53 that contains a near field lens assembly and the gap control/runout signal 51 also is input to the tilt angle calculation 57. A measurement signal 56 for the tangential position (the linear velocity of the disc) from the gap actuator 55 is also input into the tilt angle calculation 57. The tilt angle calculation can provide a good measure for the local tangential tilt angle φ using these inputs.

The gap control/runout signal 51 is directly proportional to the displacement of the disc as determined by the axial runout. Axial runout can be determined using any conventional procedure. The optics and hardware required to generate control signal 51 and determine the local tangential tilt angle φ are generally present in currently existing drives having near field lens assemblies. Therefore, minor modifications to existing software and control signals are all that is required to provide a good measure for the local tangential tilt angle φ.

Still referring to FIG. 5, tilt angle calculation 57 generates the tilt angle φ by taking the derivative of the runout r with respect to the tangential position x. Actually, the derivative of the runout r with respect to the tangential position x will yield the tan φ, which can be approximated as being equal to φ at small angles. The tilt angle φ that is calculated by the tilt angle calculation 57 is input to the tilt control 59 which generates the tilt control signal 61 to the lens title actuator 53 to keep the runout of disc 10 under control. The current tangential position x may be obtained from the linear disc velocity for a given clock frequency. As an example, the derivative may be calculated as Δr/Δx, with Δr the difference between consecutive samples of the runout r (possibly a smoothed version), and with Δx the displacement in the tangential direction in the time interval between the aforementioned samples of the runout r. At a fixed sampling frequency of the runout r, Δx will be a constant which can be calculated directly from the linear disc velocity and the sampling frequency.

As an example, the tilt angle φ can be calculated in this way from the runout measurements, as shown in FIG. 4. FIG. 4 illustrates the axial runout 41 and corresponding tangential tilt 45 that results over almost two rotations of a disc, such as a polycarbonate disc have a thick of 1.2 mm and a radius of about 35 mm. As clearly evident from FIG. 4, the tangential tilt 45 is zero and the local maximum and minimum points for the axial runout 41.

Alternatively, the focus control signal from a far field focus actuator can be used to provide the local tangential tilt angle φ. This has the advantage that the distance between lens and disc is much larger, so that this approach is completely safe for the disc and the near field lens.

The disc skew correction methods may be improved by not minimizing the peak-to-peak value of the runout signal, but by minimizing the maximum tangential tilt angle.

In order to check tangential tilt angles, once the calculated tilt angle exceeds a certain prescribed value (this means e.g. a badly deformed disc, outside the specifications of the system, with tilt angles close to or even larger than the sum of the maximum lens tilt and the mechanical tilt margin between the lens and the disc), it is highly recommended to pull back the lens in order to avoid damage to lens and/or disc, stop operation of the drive and refuse the disc with a corresponding error message. Additionally, it should be noted that the foregoing can be implement using a near field lens set-up or a far field lens as previously discussed can also be used here as well.

Alternatively, if the disc is warped but not to the extent that is outside the specifications of the system, dynamically adjusting the tangential lens tilt can be accomplished. The tangential disc tilt can be (partly) compensated by dynamically adjusting the tangential tilt of the near field lens. The useful tilt range of the lens is limited (typically to around 0.5 mrad lens field adjustment using Gap Signal), pre-alignment of the record carrier is highly preferable, e.g. on a stationary disc, so that the dynamic method presented here only needs to correct the local variations in the disc shape (pre-alignment minimizes ‘DC’ tilt offset).

The bandwidth of the lens tilt mechanism and its control system need to be sufficiently high for high disc rotation speeds and thus data rates, i.e. several times the maximum rotation speed of the disc (bandwidth in the order of several 100 Hz or higher) in order to follow the variations in the disc shape. This implies that the mass of the controlled element needs to be quite small. For this reason, the Optical Pick-up Unit (OPU) tilting or disc motor tilting are not so suitable for dynamic tangential tilt correction, and a direct tilting action of the objective lens e.g. by a so-called 3D actuator such as used in current commercial products is the most promising option. The lens is tilted in response to a suitable control signal, which is proportional to the tangential tilt angle as determined by a method such as described under point 1. This control signal is then used in a tilt control system, for example a feedforward system, to adjust the lens tilt by means of a tilt (3D) actuator or similar means, as depicted schematically in FIG. 5.

To avoid problems with gap servo stability, too large lens tilts should be avoided. This can for example be done in the tilt control circuit by limiting the output tilt control signal to pre-described safe values. The current value of the gap signal (GS) can also be used as a running safety control signal: its value should not drop below a certain fraction, e.g. 0.9 of its nominal value.

1. A method for handling tilt within optical disc systems comprising:
determining a tangential tilt angle for an optical media within an optical disc system using a measurement for axial runout for the optical media;
comparing the tilt angle with a predetermined threshold; and
responding to the comparing step by compensating for the tilt angle or not allowing the optical media to be used within the optical disc system if the predetermined threshold is met.

2. The method of claim 1, wherein the tangential tilt angle is obtained using a focus control from a focus actuator.

3. The method of claim 1, wherein the tangential tilt angle is obtained using a control signal indicative of a near field gap width.

4. The method of claim 3, wherein the control signal indicative of the near field gap width is obtained from a near filed gap actuator.

5. The method of claim 1, wherein determining further comprises taking a rate of change of axial runout with respect to a tangential position representing linear disc velocity.

6. The method of claim 5, wherein determining further comprises taking the rate of change of axial runout with respect to the tangential position represents a tangent of the tilt angle.

7. The method of claim 1, wherein responding further comprises taking action to prevent damage to optics.

8. The method of claim 1, wherein responding further comprises adjusting the tilt of a near field lens.

9. The method of claim 8, wherein responding further comprises pre-aligning the optical disc prior adjusting the tilt of the near field lens.

10. The method of claim 9, wherein pre-aligning further comprises pre-aligning the optical disc while the optical disc is stationary.

11. The method of claim 8, wherein adjusting the tilt of the near field lens further comprises adjusting the tilt at multiple times a maximum rotation speed for the optical disc.

12. The method of claim 8, wherein adjusting the tilt of the near field lens further comprises limiting a maximum tilt to a predetermined maximum value.

13. An optical disc system for handling tilt comprising:
a tangential tilt angle determination device that uses a measurement for axial runout for an optical media to determine the tangential tilt angle of optical disc;
a comparison mechanism that compares the tangential tilt angle with a predetermined threshold; and
a compensation device that responds to the result of the comparison mechanism to correct for the tilt angle or not allow the optical media to be used within the optical disc system if the predetermined threshold is met.

14. The system of claim 13, wherein the tangential tilt angle is obtained using a focus control from a focus actuator.

15. The system of claim 13, wherein the tangential tilt angle is obtained using a control signal indicative of a near field gap width.

16. The system of claim 15, wherein the control signal indicative of the near field gap width is obtained from a near filed gap actuator.

17. The system of claim 13, wherein the tangential tilt angle determination device employs a rate of change of the axial runout with respect to a tangential position representing linear disc velocity of the optical disc to determine the tangential tilt angle.

18. The system of claim 14, wherein the tangential tilt angle determination device further comprises taking the rate of change of the axial runout with respect to the tangential position to derive a tangent of the tangential tilt angle.

19. The system of claim 13, wherein the compensation device further comprises responding by taking action to prevent damage to optics.

20. The system of claim 13, wherein the compensation device responds by adjusting the tilt of a near field lens.

21. The system of claim 20, wherein the compensation device that responds by pre-aligning the optical disc prior adjusting the tilt of the near field lens.

22. The method of claim 21, the compensation device that pre-aligns the optical disc while the optical disc is stationary.

23. The method of claim 20, wherein the adjusting of the tilt of the near field lens further comprises adjusting the tilt at multiple times a maximum rotation speed for the optical disc.

24. The method of claim 20, wherein adjusting the tilt of the near field lens further comprises limiting a maximum tilt to a predetermined maximum value.
